(19) United States
(12) Patent Application Publication
(10) Pub. No.: US 2026/0037258 A1
(43) Pub. Date: Feb. 5, 2026

(54) METHOD AND APPARATUS FOR PROCESSING MULTIMEDIA DATA FLOWS BY DECOUPLING AVSTREAM DRIVER FROM MULTIMEDIA DATA FLOWS AND USING USERSPACE-DRIVEN DATA FLOW MODEL

(71) Applicant: MEDIATEK INC., Hsin-Chu (TW)

(72) Inventors: Chun-Chuan Yang, Hsinchu City (TW); Xilei Huang, Hefei (CN)

(73) Assignee: MEDIATEK INC., Hsin-Chu (TW)

(21) Appl. No.: 18/806,690

(22) Filed: Aug. 15, 2024

(30) Foreign Application Priority Data
Jul. 30, 2024 (CN) 202411034803.9

(51) Int. Cl. G06F 8/76

(52) U.S. Cl. CPC G06F 8/76

(57) ABSTRACT

A computing device includes a machine-readable medium and a processing circuit. The machine-readable medium stores instructions. The processing circuit loads and executes the instructions. The instructions include a Windows operating system, an AVStream driver, and a multimedia data flow model. The AVStream driver is executable within the Windows operating system, wherein each AVStream pin of the AVStream driver is defined to be decoupled from multimedia data flows. The multimedia data flow model is executable within the Windows operating system, wherein the multimedia data flow model is used to deal with at least the multimedia data flows in a processing style adopted in a non-Windows operating system when being executed.

### BACKGROUND

The present invention relates to processing multimedia data flows, and more particularly, to a method and apparatus for processing multimedia data flows by decoupling a Windows AVStream driver from the multimedia data flows and using a userspace-driven data flow module.

Conventional data flow models may be categorized into kernel-driven data flow models and userspace-driven data flow models. Regarding a kernel-driven data flow model, data flows are triggered by the kernel, and the user space only receives the data flows delivered from the kernel. Regarding a userspace-driven data flow model, data flows are triggered by the user space, and the kernel provides the data flows requested by the user space. Since a framework of the kernel-driven data flow model does not match a framework of the userspace-driven data flow model, directly replacing the kernel-driven data flow model by the userspace-driven data flow model may be unworkable in most cases. Thus, there is a need for an innovative design which allows the userspace-driven data flow model supported by a first operating system to be implemented in a second operating system that originally supports the kernel-driven data flow model.

### SUMMARY

One of the objectives of the claimed invention is to provide a method and apparatus for processing multimedia data flows by decoupling a Windows AVStream driver from the multimedia data flows and using a userspace-driven data flow module. For example, each AVStream pin of a Windows AVStream driver is decoupled from multimedia data flows, and a multimedia data flow module that deals with the multimedia data flows operates in a processing style adopted in a non-Windows operating system.

According to a first aspect of the present invention, an exemplary computing device is disclosed. The exemplary computing device includes a machine-readable medium and a processing circuit. The machine-readable medium is configured to store instructions. The processing circuit is configured to load and execute the instructions. The instructions include a Windows operating system; an AVStream driver, executable within the Windows operating system, wherein each AVStream pin of the AVStream driver is defined to be decoupled from multimedia data flows; and a multimedia data flow model, executable within the Windows operating system, wherein the multimedia data flow model is configured to deal with at least the multimedia data flows in a processing style adopted in a non-Windows operating system when being executed.

According to a second aspect of the present invention, an exemplary data processing method is disclosed. The exemplary data processing method includes: executing an AVStream driver within a Windows operating system; decoupling each AVStream pin of the AVStream driver from multimedia data flows; and executing a multimedia data flow model within the Windows operating system, to deal with at least the multimedia data flows in a processing style adopted in a non-Windows operating system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a computing device according to an embodiment of the present invention.

FIG. 2 is a diagram illustrating comparison between a typical Android data flow design, a typical Windows data flow design, and a proposed data flow design.

FIG. 3 is a diagram illustrating a camera software design with core functions shared between a Windows platform and an Android platform according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

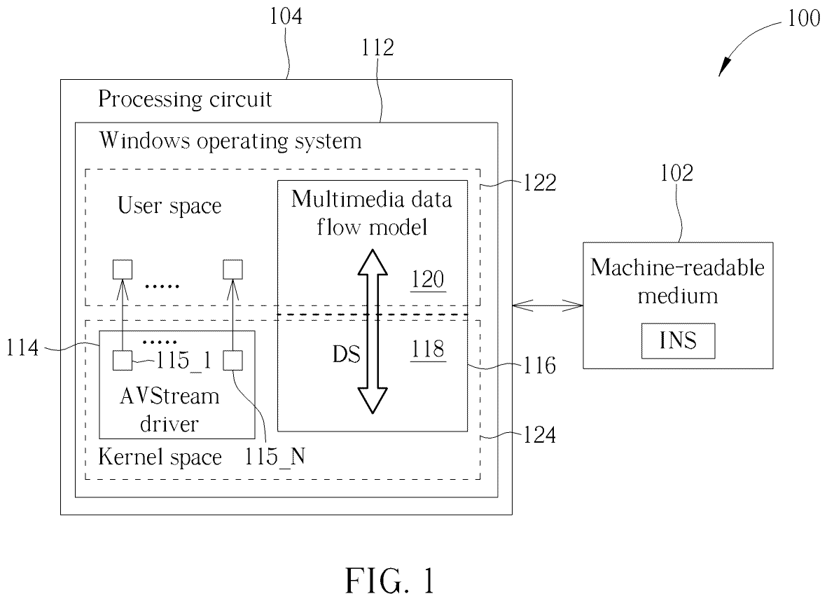

FIG. 1 is a diagram illustrating a computing device according to an embodiment of the present invention. The computing device 100 may include a machine-readable medium 102 and a processing circuit 104. For example, the machine-readable medium 102 may be a memory such as a dynamic random access memory (DRAM), and the processing circuit 104 may be a central processing unit (CPU) such as a general-purpose processor. The machine-readable medium 102 is configured to store instructions INS. The processing circuit 104 is configured to load and execute the instructions INS. In this embodiment, the instructions INS running on the processing circuit 104 may include a Windows operating system 112, an AVStream driver 114, and a multimedia data flow model 116. It should be noted that only the components pertinent to the present invention are illustrated. In practice, the computing device 100 may include additional components to achieve other designed functions, and the instructions INS running on the processing circuit 104 may include other software modules to achieve other designed functions.

The AVStream driver 114 is executable within the Windows operating system 112. More specifically, the AVStream driver 114 is executed in a kernel space 124 of the Windows operating system 112. In this embodiment, the AVStream driver 114 may create one or more AVStream pins 115_1-115_N (N≥1), where each AVStream pin of the AVStream driver 114 is defined to be decoupled from multimedia data flows DS. This means that these AVStream pins 115_1-115_N (N≥1) do not directly depend on the specific content and structure of the multimedia data flows DS when operating and processing data. In other words, the design and functionality of the AVStream pins 115_1-115_N are not fixed for specific types or formats of data flows, but are versatile and capable of handling various types of data flows. For example, the multimedia data flows DS may be camera-related data flows (e.g. video data and/or video-related meta data) derived from data output by a hardware camera module (not shown). Hence, in this embodiment, the AVStream pins 115_1-115_N may not be particularly tied to the camera-related data flows. Furthermore, since AVStream pins 115_1-115_N are not dependent on specific content of data flows, they can receive and process multimedia data flows from different sources, such as video, audio, or other forms of data produced by various types of hardware devices. This design allows AVStream pins 115_1-115_N (N≥1) to process data more flexibly and independently, improving the modularity and scalability of the system. More specifically, decoupling allows the various part of the AVStream driver 114 to be developed and maintained independently, meaning that the pin processing logic can be replaced or updated separately without affecting other parts, thereby enhancing the modularity of the system. As new multimedia formats and data types emerge, the decoupled design enables the AVStream driver 114 to be more easily extended to support these new formats without the need for large-scale changes to existing system, thus improving the system's scalability. Additionally, because the decoupled pins are not limited by specific data flow formats, they can more easily collaborate with different software and hardware components.

The multimedia data flow model 116 is executable within the Windows operating system 112. For example, the multimedia data flow model 116 may be a 2-stage data flow model including a first stage 118 and a second stage 120, where the first stage 118 is executed in the kernel space 124 of the Windows operating system 112, and the second stage 120 is executed in a user space 122 of the Windows operating system 112. In this embodiment, the multimedia data flow model 116 is configured to deal with at least the multimedia data flows DS in a processing style adopted in a non-Windows operating system when being executed within the Windows operating system 112. For example, the non-Windows operating system may be a Linux-based operating system such as an Android operating system, and the processing style may be in compliance with a video for Linux version two (V4L2) style.

The Windows operating system 112 requires the use of the AVStream driver 114 (which is part of a kernel-driven data flow model), and the AVStream driver 114 is required to create at least one AVStream pin 115_1-115_N (N≥1). For example, the AVStream driver 114 may create only a single AVStream pin 115_1 (N=1) to meet the minimum requirements of the Windows operating system 112. However, the Windows operating system 112 has no constraints on the type of information delivered over the at least one AVStream pin 115_1-115_N (N≥1). Based on such observations, the present invention proposes decoupling each AVStream pin 115_1-115_N (N≥1) of the AVStream driver (which is a vender-specific driver) 114 executed in the kernel space 124 of the Windows operating system 112 from the multimedia data flows (e.g., camera related data flows) DS, thereby allowing the multimedia data flow model (which may include vender-specific software modules) 116 to deal with at least the multimedia data flows DS in a processing style (e.g., Android/Linux V4L2 style) distinct from the Windows AVStream style.

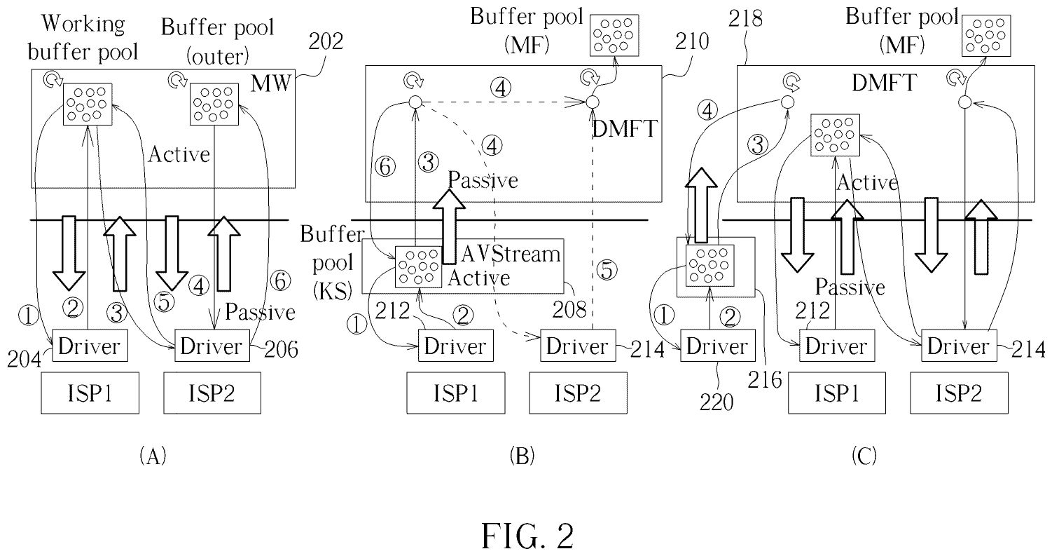

For better comprehension of technical features of the present invention, comparison between a typical Android data flow design, a typical Windows data flow design, and a proposed data flow design is illustrated in FIG. 2. The sub-diagram (A) of FIG. 2 illustrates the typical Android data flow design that employs a 2-stage userspace-driven (userspace-triggered) data flow model. The middleware (MW) 202 executed in the user space of the Android operating system acts as an active role of requesting multimedia data flows from drivers 204, 206 of a stage-1 image signal processor (ISP1) and a stage-2 image signal processor (ISP2), and each of the drivers 204, 206 executed in the kernel space of the Android operating system acts as a passive role for responding the requested multimedia data flows to the MW 202.

The sub-diagram (B) of FIG. 2 illustrates the typical Windows data flow design employs that a 2-stage kernel-driven (kernel-triggered) data flow model. The AVStream driver 208 executed in the kernel space of the Windows operating system acts as an active role for obtaining multimedia data flows from drivers 212, 214 of a stage-1 image signal processor (ISP1) and a stage-2 image signal processor (ISP2) and delivering obtained multimedia data flows to a device media foundation transform (DMFT) 210, and the DMFT 210 executed in the user space of the Windows operating system acts as a passive role for receiving multimedia data flows sent from the AVStream driver 208.

The sub-diagram (C) of FIG. 2 illustrates the proposed data flow design that allows a 2-stage userspace-driven (userspace-triggered) data flow model to operate under a Windows operation system requiring the use of an AVStream driver. In accordance with the proposed data flow design, the AVStream driver 216 is decoupled from multimedia data flows between the drivers 212, 214 (passive roles) executed in the kernel space of the Windows operating system and the DMFT 218 (active role) executed in the user space of the Windows operating system, and interacts with a driver 220 that has nothing to do with multimedia data flows. For example, none of data flows between the driver 220 and the AVStream driver 216 is derived from a video/image output of a hardware camera module. For another example, an AVStream pin of the AVStream driver 216 may be configured to act as a channel for controlling a state machine. With the help of decoupling of the AVStream driver 216, a 2-stage userspace-triggered data flow model executed within the Windows operating system can be realized. The 2-stage userspace-triggered data flow model executed within the Windows operating system is similar to that executed within the Android operating system. Hence, source codes used for building software modules of the userspace-driven data flow model executable within the Android operating system may be reused to build software modules of the userspace-driven data flow model executable within the Windows operating system.

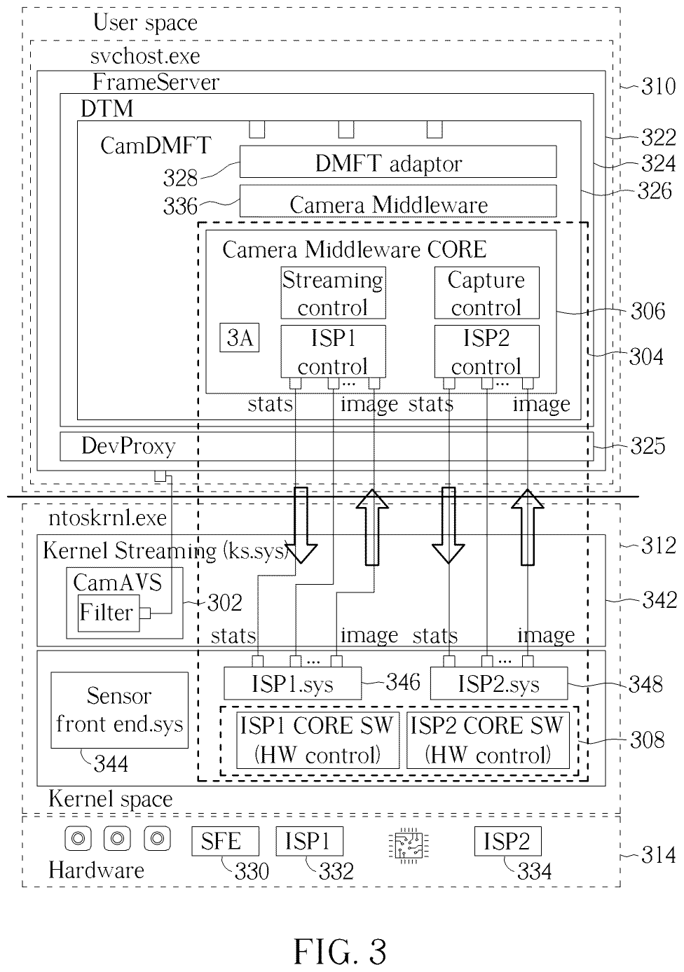

FIG. 3 is a diagram illustrating a camera software design with core functions shared between a Windows platform and an Android platform according to an embodiment of the present invention. The hardware 314 of a camera module may include a sensor front end (SFE) 330, a stage-1 ISP (labeled by “ISP1”) 332, and a stage-2 ISP (labeled by “ISP2”) 334. Regarding the user space 310 of the Windows operating system, a device transform manager (DTM) 324 and a DevProxy 325 are executed within a Windows camera frame server (labeled by “FrameServer”) 322, a device media foundation transform (labeled by “CamDMFT”) 326 is executed within the DTM 324, and a DMFT adaptor 328, a camera middleware 336, and a camera middleware core 306 are executed within the CamDMFT 326, where the camera middleware core 306 is a software module that includes core functions and is built from compiling a same source code of a software module executed within an Android/Linux operation system.

Regarding the kernel space 312 of the Windows operating system, multiple drivers are executed. For example, the drivers may include a kernel streaming driver (ks.sys) 342 that supports kernel-mode processing of streamed data, a sensor front end driver (sensor front end.sys) 344 for accessing the SFE 330, a stage-1 ISP driver (ISP1.sys) 346 for accessing ISP1 332, a stage-2 ISP driver (ISP2.sys) 348 for accessing ISP2 334, and a software module 308 that includes core functions such as ISP1 hardware control and ISP2 hardware control, where the software module 308 is built from compiling a same source code of a software module executed within an Android/Linux operation system.

As shown in FIG. 3, the camera software has a camera AVStream driver (labeled by “CamAVS”) 302, and employs a camera data flow model (which has a 2-stage structure similar to that of an Android/Linux V4L2 camera data flow model) 304. For example, the AVStream driver 114 shown in FIG. 1 may be implemented using the camera AVStream driver 302, and the multimedia data flow model 116 shown in FIG. 1 may be implemented using the camera data flow model 304. In this embodiment, the camera data flow model 304 includes one software module (e.g., camera middleware core 306) executed within the user space 310 of the Windows operating system, another software module (e.g., software module 308) executed within the kernel space 312 of the Windows operating system, and other necessary software modules. In this embodiment, the user-mode software module (e.g., camera middleware core 306) includes core functions such as 3A (auto exposure (AE)/auto white balance (AWB)/auto focus (AF)), streaming control, capture control, ISP1 control (e.g., ISP1 flow control), and ISP2 control (e.g., ISP2 flow control), and the kernel-mode software module (e.g., software module 308) includes core functions such as ISP1 hardware control and ISP2 hardware control. Since the camera data flow model 304 executed within the Windows operation system has a 2-stage structure similar to that of an Android/Linux V4L2 camera data flow model, the user-mode software module of the camera data flow model 304 can be built from compiling a same source code of a software module executable within the Android/Linux operating system, and/or the kernel-mode software module of the camera data flow model 304 can be built from compiling a same source code of a software module executable within the Android/Linux operating system. To put it simply, with the help of decoupling of the AVStream driver that is required by the Windows operating system, a 2-stage userspace-triggered data flow model executed within the Windows operating system can be realized, and the laborious work of designing the Windows camera software can be greatly simplified by reusing the existing source code used to build software modules of the Android/Linux camera software.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computing device comprising:
a machine-readable medium, configured to store instructions; and
a processing circuit, configured to load and execute the instructions, wherein the instructions comprise:
a Windows operating system;
an AVStream driver, executable within the Windows operating system, wherein each AVStream pin of the AVStream driver is defined to be decoupled from multimedia data flows; and
a multimedia data flow model, executable within the Windows operating system, wherein the multimedia data flow model is configured to deal with at least the multimedia data flows in a processing style adopted in a non-Windows operating system when being executed.

2. The computing device of claim 1, wherein the multimedia data flows comprise camera related data flows.

3. The computing device of claim 1, wherein the non-Windows operating system is a Linux-based operating system.

4. The computing device of claim 3, wherein the processing style adopted for dealing with at least the multimedia data flows is in compliance with a video for Linux version two (V4L2) style.

5. The computing device of claim 1, wherein the multimedia data flow model comprises a software module, executable within a user space of the Windows operating system; and the software module is built from compiling a same source code of a software module executable within the non-Windows operating system.

6. The computing device of claim 1, wherein the multimedia data flow model comprises a software module, executable within a kernel space of the Windows operating system; and the software module is built from compiling a same source code of a software module executable within the non-Windows operating system.

7. A data processing method comprising:
executing an AVStream driver within a Windows operating system;
decoupling each AVStream pin of the AVStream driver from multimedia data flows; and
executing a multimedia data flow model within the Windows operating system, to deal with at least the multimedia data flows in a processing style adopted in a non-Windows operating system.

8. The data processing method of claim 7, wherein the multimedia data flows comprise camera related data flows.

9. The data processing method of claim 7, wherein the non-Windows operating system is a Linux-based operating system.

10. The data processing method of claim 9, wherein the processing style adopted for dealing with at least the multimedia data flows is in compliance with a video for Linux version two (V4L2) style.

11. The data processing method of claim 7, wherein the multimedia data flow model comprises a software module executed within a user space of the Windows operating system; and the software module is built from compiling a same source code of a software module executable within the non-Windows operating system.

12. The data processing method of claim 7, wherein the multimedia data flow model comprises a software module executed within a kernel space of the Windows operating system; and the software module is built from compiling a same source code of a software module executable within the non-Windows operating system.
